(19) United States
(12) Patent Application Publication
(10) Pub. No.: US 2015/0149331 A1
(43) Pub. Date: May 28, 2015

(54) Taking Device Inventory using Dynamically Generated Symbols

(71) Applicant: Texas Instruments Incorporated, Dallas, TX (US)

(72) Inventor: Binu Ariyappallil Joseph, Rowlett, TX (US)

(73) Assignee: Texas Instruments Incorporated, Dallas, TX (US)

(21) Appl. No.: 14/090,881

(22) Filed: Nov. 26, 2013

(51) Int. Cl. G06Q 10/08

(52) U.S. Cl. CPC G06Q 10/087
USPC 705/28

(57) ABSTRACT

A method for inventorying one or more devices may be initiated by receiving an input command to request a device identification (ID) for one of the devices. A unique ID image that is indicative of the ID of one device may then be dynamically created. The unique ID image may be displayed on a display screen coupled to the one device, whereby the unique ID image is available to be observed by an inventory input device. The unique ID image may be a quick response (QR) bar code. The display screen may be part of a hand-held calculator, and the one device may be a network module coupled to the hand-held calculator.

### BACKGROUND OF THE INVENTION

1. Field of the Invention

Embodiments of the present invention generally relate to taking an inventory of devices in order to allow connection to a network.

2. Description of the Related Art

With ever increasing frequency, school classrooms are equipped with a classroom learning system in which digital devices, e.g., handheld calculators, for student use are connected via a network to a host computer used by the teacher. Such a classroom learning system allows a teacher to perform actions such as creating and managing lessons, transferring files between the computer and the digital devices, monitoring student activity on the digital devices using screen captures, polling, assessments, etc., and performing various interactive activities with the students. Various tools are also provided for creating, distributing, and analyzing educational content. The TI-Nspire™ Navigator™ System from Texas Instruments, Inc. is an example of such a classroom learning system.

QR code (abbreviated from Quick Response Code) is the trademark for a type of matrix barcode (or two-dimensional barcode) first designed for the automotive industry in Japan. A barcode is an optically machine-readable label that is attached to an item and that records information related to that item. The standardized information encoded by a QR code may be numeric, alphanumeric, byte/binary, and Kanji. Virtually any type of data may be encoded by using various extensions. The QR Code system has become popular outside the automotive industry due to its fast readability and greater storage capacity compared to standard UPC barcodes. Applications include product tracking, item identification, time tracking, document management, general marketing, etc.

### SUMMARY

Embodiments of the present invention relate to methods and systems for inventorying one or more devices that may be initiated by receiving an input command to request a device identification (ID) for one of the devices. A unique ID image that is indicative of the ID of one device may then be dynamically created. The unique ID image may be displayed on a display screen coupled to the one device, whereby the unique ID image is available to be observed by an inventory input device, such as a camera. The unique ID image may be a quick response (QR) bar code, for example. The display screen may be part of a hand-held calculator, and the device may be a network module coupled to the hand-held calculator.

### BRIEF DESCRIPTION OF THE DRAWINGS

Particular embodiments in accordance with the invention will now be described, by way of example, and with reference to the accompanying drawings:

FIGS. 1 and 2 show examples of classroom networks;

FIG. 3 shows an example of a handheld calculator;

FIG. 4 is a block diagram of a handheld calculator;

FIG. 5 is a block diagram of a classroom network architecture;

FIG. 6 illustrates a QR code on the display of a handheld calculator;

FIG. 7 illustrates various configurations of QR codes;

FIG. 8 is a block diagram of a computer node for the classroom network of FIG. 1; and

FIG. 9 is a flow diagram of a method for taking inventory of handheld calculator devices and accessory devices.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Embodiments of the invention provide for automatic association of portable wireless devices with the correct classroom network. An SSID is the unique name (identifier) of a wireless local area network that differentiates one network from other networks. In the normal mode, the handheld calculator connects to the network to perform data exchanges such as documents, questions, etc. under the control of the network host computer, e.g., the computer used by the teacher. To provide a secure environment, only devices associated with the classroom network may be allowed to connect to the classroom network. That is, in some embodiments, the classroom network may be configured to accept connections from the handheld calculators associated with that network and to reject connections from any other handheld calculators.

Determining which devices should be allowed to connect to a classroom network may require the teacher to take an inventory of the devices and accessory devices used by the students in that classroom group. Previously, such an inventory involved manually entering serial numbers or other identification numbers. Other techniques involve using bar codes attached to the devices or by using radio frequency identification tags (RFID) that are attached to the devices. Embodiments of the invention allow a teacher to inventory all of the devices in the classroom by simply taking a picture of a unique QR code that is dynamically generated and displayed on the screen of each handheld calculator in the classroom, as will be descried in more detail below. The pictures may be taken using a camera attached to the teacher's system, for example, or by a smart phone that may be coupled to the teacher's system, for example.

Identifying information for each accepted device, e.g., the media access control (MAC) address of the device may then be stored for use during normal operation to restrict access to the network to those accepted devices. When the network administrator is ready to begin a normal classroom network session, the network configuration is returned to normal mode. In the normal operation configuration, only previously accepted wireless devices are allowed to join the classroom network. In this normal mode, wireless devices on the network are permitted to perform normal network activities that are normally performed on the classroom network.

In some embodiments, the inventory process may be performed one time, such as prior to the first normal classroom network use, and the results of the inventory and association process saved. Each day when normal classroom network activities are started and the wireless devices are turned on, they may request entry into all networks found. The network host may check the identification information of accepted wireless devices and grant entry only to known and accepted devices.

Note that it is possible to transport an entire classroom network from one classroom to another classroom without loss of network association since the device associations are maintained on the network host. In some school systems, the classroom network is shared between multiple teachers in different classrooms. Further, the saved associations between wireless devices and the classroom networks can be maintained centrally for several co-located networks. This allows a central administrator to edit/maintain/change associations easily, for example.

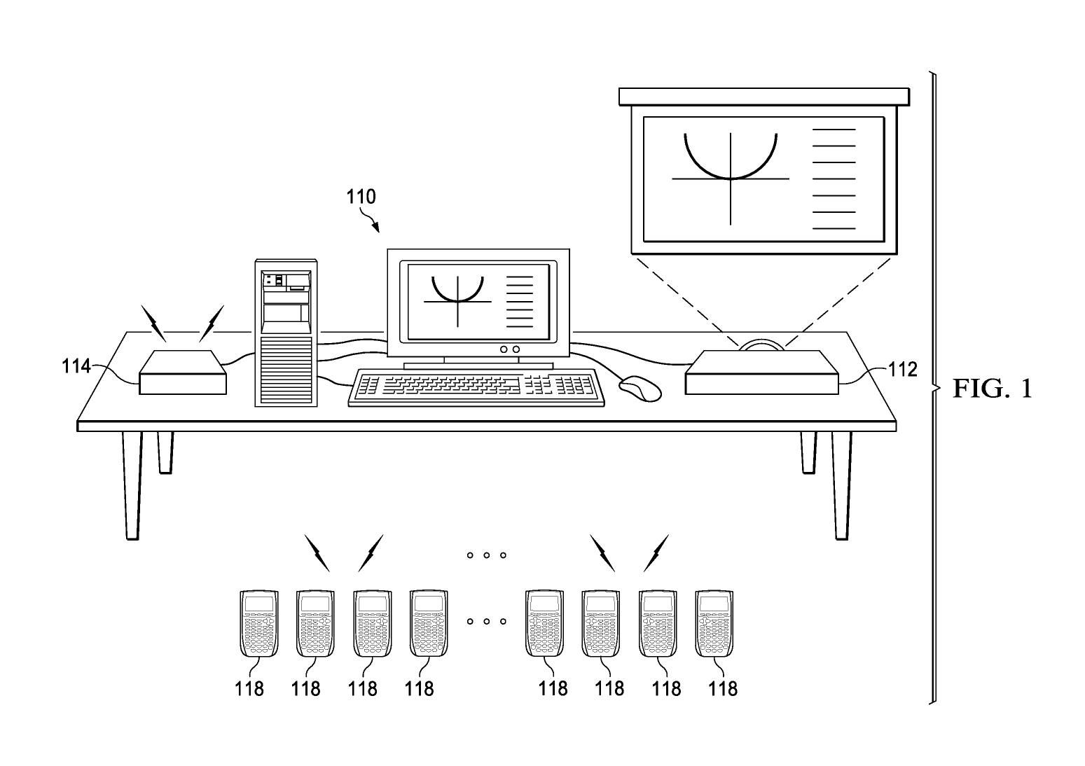

FIG. 1 shows a diagram of a classroom network configured to perform network association methods as described herein. As shown in FIG. 1, the classroom network includes a computer system 110 communicatively coupled to a projector 112 (e.g., a digital projector), which may project images and video provided by the computer system 110 onto a wall, screen, or other surface. Computer system 110 includes presentation software (not shown) for managing the presentation of screen content received from a handheld calculator as the handheld calculator is operated. The presentation may be made using a display device in the computer system 110, or using a combination of the display device and the projector 112. The computer system 110 may be any general purpose computing device, such as a desktop computer, a mini-computer, a main frame, a laptop computer, a netbook, a tablet computer, or the like.

The computer system 110 is also communicatively coupled to an access point 114 via a Universal Serial Bus (USB) connection, for example. The access point 114 provides a wireless interface such as 802.11b, 802.11g, or the like for the computer system 110 to communicate with one or more handheld calculators 118. Once connected, bi-directional communications may be performed between the handheld calculators 118 and the computer system 110 via the access point 114. The computer system 110 and the access point 114 are illustrated as separate components for illustrative purposes only. In some embodiments, the access point 114 may be integrated into the computer system 110. Further, the coupling between the access point 114 and the computer system 110 may be any suitable wired or wireless connection. The combination of the computer system 110 and the access point 114 are the network host for the classroom network.

The handheld calculators 118 may be any suitable handheld calculators, such as, for example, graphing calculators in the TI-Nspire product line available from Texas Instruments, Inc. To allow wireless communication with the access point 114 and/or the computer system 110, a wireless transceiver may be integrated into a handheld calculator 118 or a wireless adaptor or a wireless cradle may be externally attached via a port on a handheld calculator 118, for example.

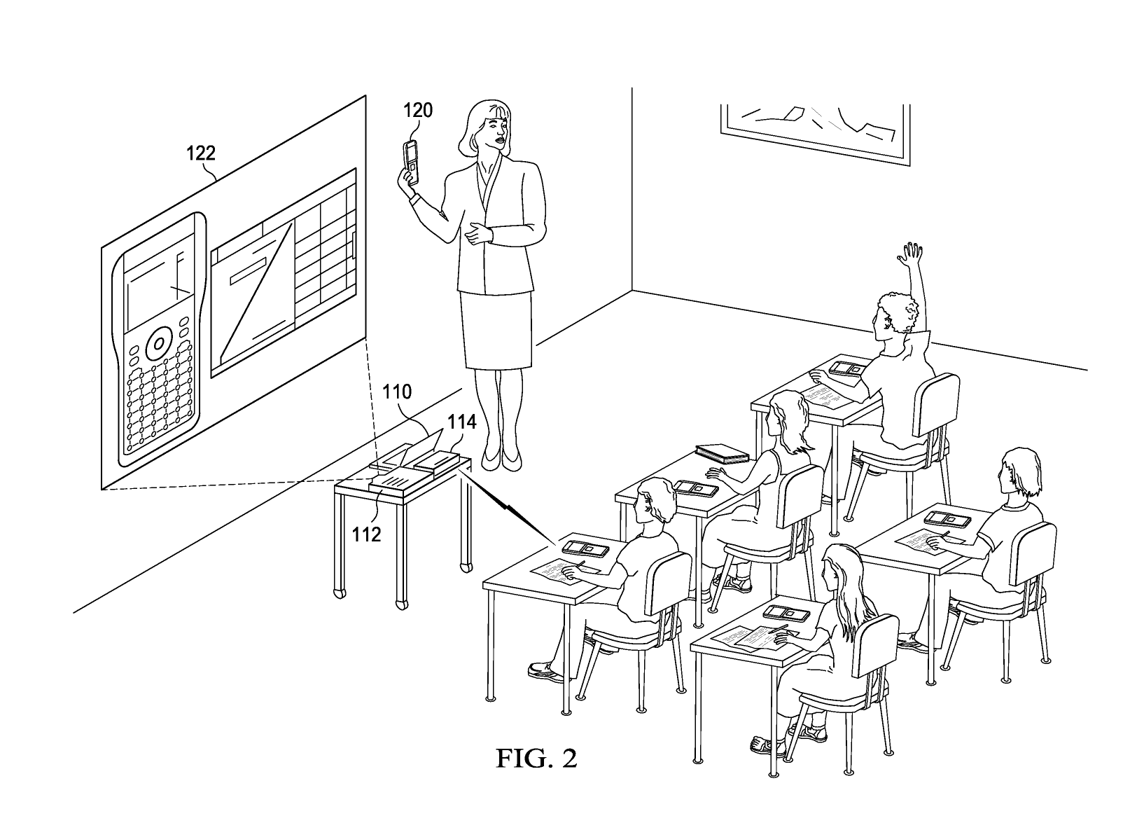

FIG. 2 shows an example of a classroom network in a classroom setting. In this embodiment, the computer system 110 is a laptop computer, and the access point 114 is connected by a USB connection to the computer system 110. The instructor's handheld calculator 120 and the handheld calculators in use by the students are all connected by a wireless communication link to the access point 114. Presentation software executing on the computer system 110 is showing the content, i.e., screen image, of the display on the instructor's handheld calculator 120 on the display device of the computer system 110 and on the screen 122 via the projector 112 along with a “skin” duplicating the appearance of the instructor's handheld calculator 120. The projector 112 is used to project the information shown on the display device onto the screen 122.

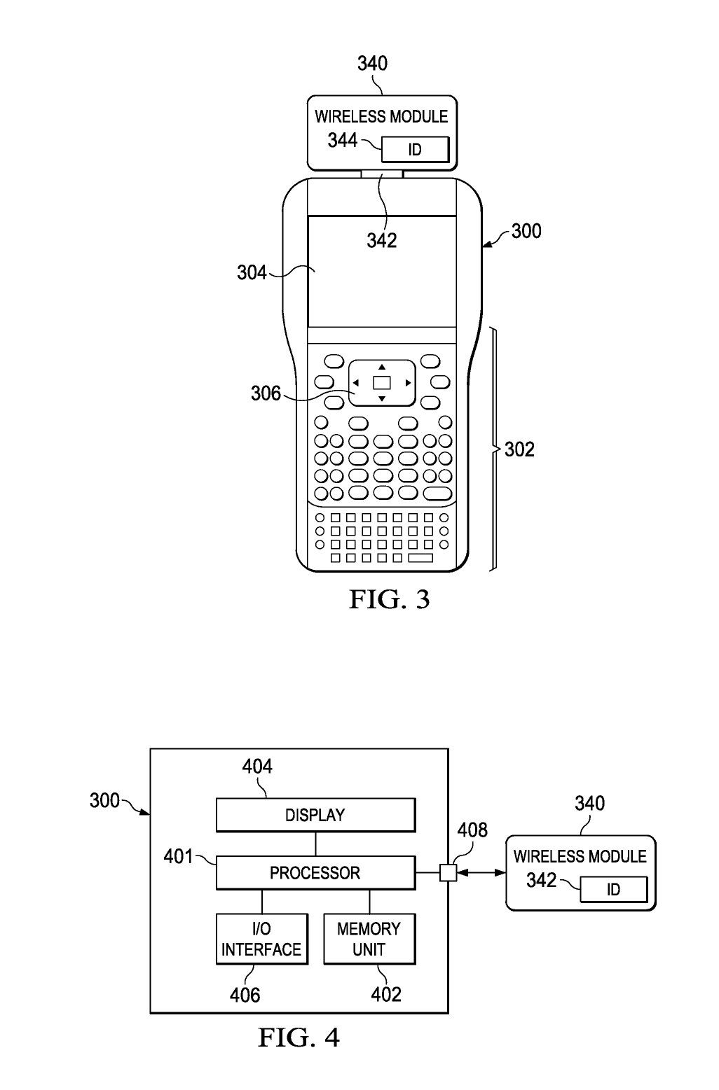

FIG. 3 shows an example of a handheld calculator 300 (e.g., 118, 120 of FIGS. 1 and 2) in accordance with one or more embodiments of the invention. For illustrative purposes, the handheld calculator illustrated in FIG. 3 is similar to graphing calculators available from Texas Instruments Inc. Handheld calculators with more or fewer components may be used in embodiments of the invention. As shown in FIG. 3, the handheld calculator 300 includes a graphical display 304, and a keypad 302 that includes a touchpad 306. The graphical display 304 may be used to display, among other things, information input to applications executing on the handheld calculator 300 and various outputs of the applications. The graphical display 304 may be, for example, an LCD display. The keypad 302 allows a user, e.g., a student or instructor, to enter data and functions and to start and interact with applications executing on the handheld calculator 300. The keypad 302 also includes an alphabetic keyboard for entering text. The touchpad 306 allows a user to interact with the display 304 by translating the motion and position of the user's fingers on the touchpad 306 to provide functionality similar to using an external pointing device, e.g., a mouse. A user may use the touchpad 306 to perform operations similar to using a pointing device on a computer system, e.g., scrolling the display 304 content, pointer positioning, selecting, highlighting, etc.

In this embodiment, wireless module 340 is communicatively coupled to calculator 300 by a connector 342. Wireless module 340 provides a wireless interface such as 802.11b, 802.11g, or the like for wireless communication with the computer system 110 using known or later developed techniques. A unique identification (ID) code 344 is included within wireless module 340. ID code 344 may be stored within a read only memory (ROM) chip, or other type of non-volatile storage device such as an electrically programmable ROM device or a flash ROM, for example.

In another embodiment, wireless module 340 with ID 344 may be included within calculator 300. In another embodiment, wireless module 340 with ID 344 may be configured as a cradle that provides physical support for calculator 300, for example.

FIG. 4 is a block diagram of the handheld calculator 300 in accordance with one or more embodiments of the invention. The handheld calculator 300 includes a processor 401 coupled to a memory unit 402, which may include one or both of read-only memory (ROM) and random-access memory (RAM). In some embodiments, the ROM stores software programs and the RAM stores intermediate data and operating results. An input/output port 408 provides connectivity to external devices, e.g., a wireless adaptor 340 or wireless cradle. In one or more embodiments, the input/output port 408 is a bi-directional connection such as a mini-A USB port. Also included in the handheld calculator 300 are a display 404 and an I/O interface 406. The I/O interface 406 provides an interface to couple input devices such as the touchpad 406 and the keypad 402 to the processor 401. In some embodiments, the handheld calculator 400 may also include an integrated wireless interface (not shown) or a port for connecting an external wireless interface (not shown). In one or more embodiments, the memory unit 402 stores software instructions to be executed by the processor 401 to implement some or all of the calculator based operations of network association methods described herein.

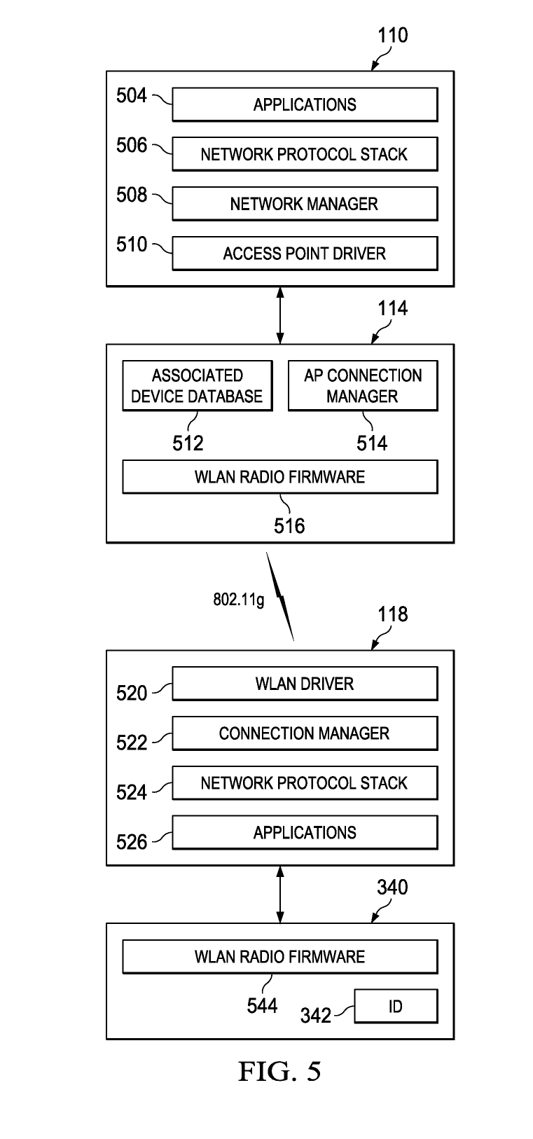

FIG. 5 is a block diagram of the classroom network communication architecture of FIGS. 1 and 2. The communication architecture includes the network host system, i.e., the computer 110 and the access point 114, and a representative calculator 118 coupled to the network via a wireless adaptor 340. The computer 110 includes an access point driver 510, a network protocol stack 506, a network manager 508, and various applications 504. Other functionality may also be present. The access point driver 510 provides functionality for bidirectional communication with the access point 114. Such communication may include sending control commands from the network manager 508 to the access point 114 to designate the network mode, i.e., configuration mode or normal mode. Such communication may also include control commands and other information from the applications 504 to be sent to the calculator 118 and the receipt of responses to the commands and other information from the calculator 118.

The network protocol stack 506 implements the network protocol suite of the classroom network on the computer 110. The network protocol stack 506 provides network communication services for the applications 504 and the network manager 508. The network protocol stack 506 may provide standard networking protocols such as transmission control protocol (TCP), user datagram protocol (UDP), internet protocol (IP) or custom protocols or a combination thereof, for example.

The applications 504 provide classroom management functionality as well as capabilities to create documents, transfer them to connected calculators, collect documents from the calculators, and to automatically grade student work. The applications 504 may also include features that allow the teacher to create and manage a classroom roster and a student portfolio. The applications may also allow the teacher to view all of the connected calculators and monitor student progress. The functionality described above may be in one application or spread across multiple applications.

The network manager 508 provides functionality for a network administrator to manage the network. For example, the network manager 508 includes a user interface that allows the network administrator to designate the operation mode of the network. The network manager 508 also includes a user interface for presenting identification information of handheld calculators requesting association with the network and for allowing the network administrator to designate which calculators to accept and which to reject. The network manager 508 may also include a user interface that allows the network administrator to edit the associated device database 512 to add and remove associated calculators.

The access point 114 includes an access point (AP) connection manager 514, an associated device database 512, and wireless local area network (WLAN) radio firmware 516. Other functionality may also be included. The WLAN radio firmware 516 provides wireless routing functionality between the access point 114 and the calculator 118. The AP connection manager 514 includes functionality to manage the connection activity between the network host and the calculators, e.g., calculator 118, using the unique ID code 342, as will be described in more detail below.

During network operation, the AP connection manager 514 causes the SSID for the classroom network to be broadcast. The AP connection manager 514 then controls which calculators are allowed to join the network based on the authentication information in the associated device database 512. That is, the AP connection manager 514 receives requests to join the network from calculators responsive to the SSID, validates the authentication information provided by the calculators against authentication information in the associated device database 512, and allows those calculators with validated authentication information to join the network. Any calculators with authentication information that does not appear in the associated device database 512 are not allowed to join.

The associated device database 512 and associated software may be stored in any suitable storage device that is accessible to the network manager application 508.

The wireless adaptor 340 includes WLAN radio firmware 544 and ID code 342, as described earlier. The wireless adaptor 340 may also include other functionality. The WLAN radio firmware 544 provides routing functionality between the calculator 118 and the access point 114.

The representative calculator 118 includes a WLAN driver 520, a network protocol stack 524, a connection manager 522, and various applications 526. The applications 526 provide the primary functionality of the calculator. The application functionality includes but is not limited to basic calculations, function graphing, geometry, and statistical analysis. The WLAN driver 520 provides a software interface to the wireless modem 340 and wireless firmware 518. The driver allows the other software modules to configure the wireless radio firmware 518. Examples of configurable parameters include the security protocol and radio channel.

The network protocol stack 524 implements the network protocol suite of the classroom network on the calculator 118. The network protocol stack 524 provides network communication services for the applications 526 and the connection manager 522. The network protocol stack 524 may provide standard networking protocols like TCP, UDP, and IP, or custom protocols or a combination thereof, for example.

The connection manager 522 includes functionality to manage connection activity between the calculator 118 and the network host system. That is, the connection manager 522 receives network SSIDs from the wireless adaptor 340 and operates the connection activity of the calculator. In some embodiments, the connection manager 522 includes functionality to display a QR code, an icon, a bar code, or other unique image on the display screen that is representative of unique ID code 342.

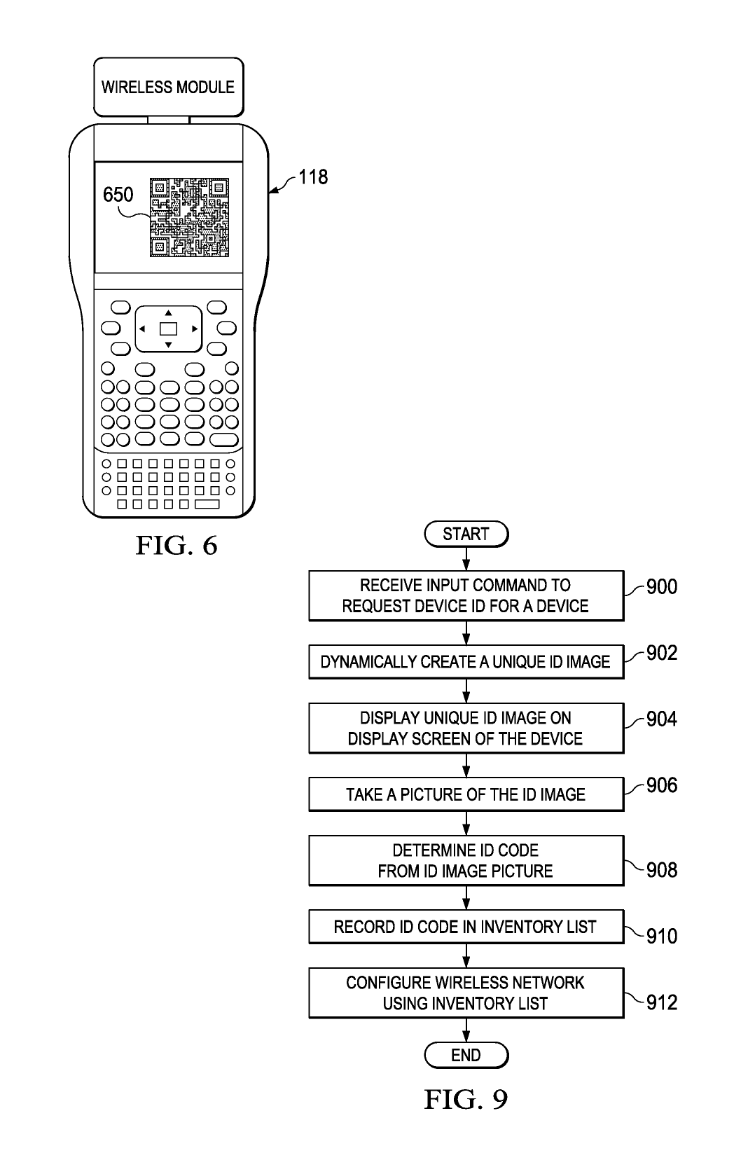

FIG. 6 illustrates a QR code 650 on the display of representative handheld calculator 118. As mentioned earlier, the standardized information encoded by a QR code may be numeric, alphanumeric, byte/binary, and Kanji, but virtually any type of data may be encoded by using various extensions. A QR code consists of black modules (square dots) arranged in a square grid on a white background which can be read by an imaging device (such as a camera) and processed using Reed-Solomon error correction until the image can be appropriately interpreted. Data may then be extracted from patterns present in both horizontal and vertical components of the image. In this manner, the unique ID code 342 for wireless device 340 may be provided in an easy to recognize format.

Determining which devices should be allowed to connect to a classroom network may require the teacher to take an inventory of the devices and accessory devices used by the children in that classroom group. Previously, such an inventory involved manually entering serial numbers or other identification numbers. Embodiments of the invention allow a teacher to inventory all of the devices in the classroom by simply taking a picture of a unique QR code that is dynamically generated and displayed on the screen of each handheld calculator in the classroom. The pictures may be taken using a camera attached to the teacher's system, for example, or by a smart phone that may be coupled to the teacher's station, for example. Each calculator may contain an application that reads the unique ID code 342 and generates a QR code that contains the ID code data, and then cause the QR code to be displayed on the display screen of the calculator. This operation may be performed in response to keypad input provided by the student, for example, when the teacher is ready to perform the inventory process.

Identifying information provided by unique ID 342 for each accepted device, e.g., the media access control (MAC) address of the device may then be stored in database 512 on the access point for use during normal operation to restrict access to the network to those accepted devices. When the network administrator is ready to begin a normal classroom network session, only previously accepted wireless devices are allowed to join the classroom network. In this manner, only wireless devices that have been inventoried by the teacher are permitted to perform normal network activities that are normally performed on the classroom network.

In some embodiments, the inventory process may be performed one time, such as prior to the first normal classroom network use, and the results of the inventory and association process saved. Each day when normal classroom network activities are started, when the wireless devices are turned on, they will request entry into all networks found. The network host will check the identification information of accepted wireless devices and grant entry only to known and accepted devices.

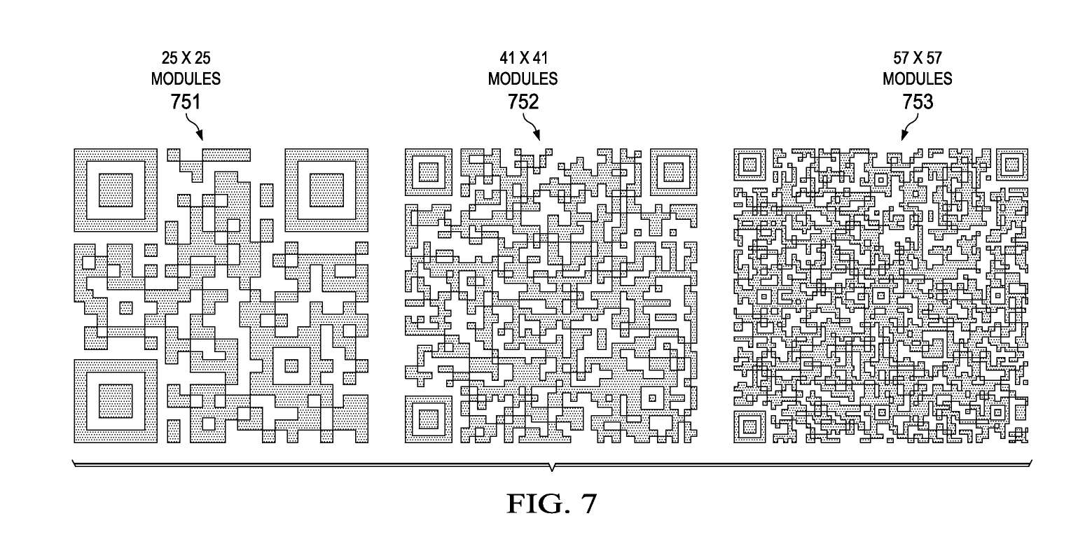

FIG. 7 illustrates various configurations of QR codes, 751-753. While embodiments of the invention described herein may use a QR code to represent the unique ID code 342, other embodiments may use other bar code configurations, icons, or even plain text that could be recognized by an optical recognition application, for example. Using QR codes provides a simple way to capture the unique ID 342 information because many smart phones now have QR reading apps that can be used by the teacher to read the QR unique QR codes displayed on each student's calculator display screen during the inventory process.

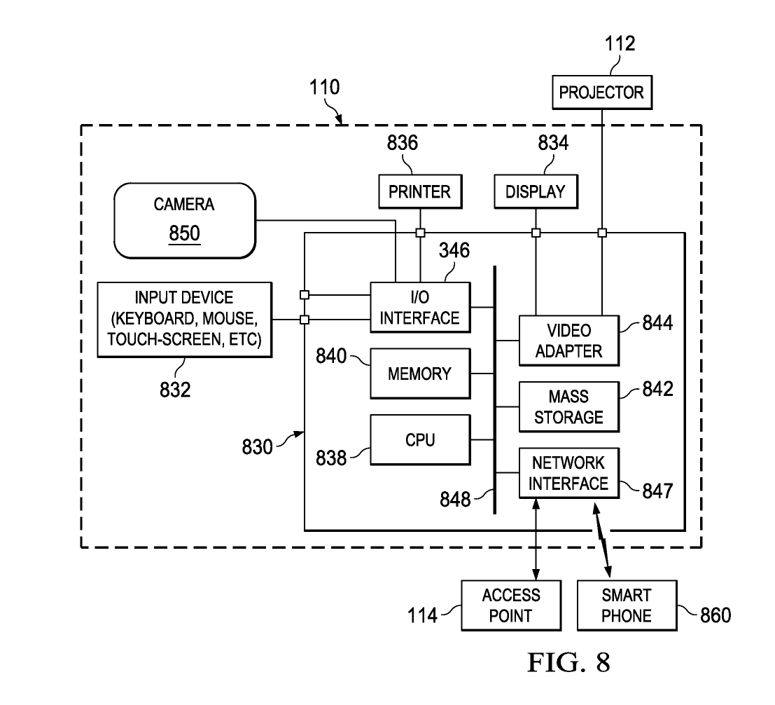

FIG. 8 is a block diagram of an example computer node 110 for the classroom network of FIGS. 1 and 2. The computer system 110 includes a processing unit 830 equipped with one or more input devices 832 (e.g., a mouse, a keyboard, or the like), and one or more output devices, such as a display 834, a printer 836, or the like. In some embodiments of the invention, the display 834 may be touch screen, thus allowing the display 834 to also function as an input device. The processing unit 830 may be, for example, a desktop computer, a workstation, a laptop computer, a dedicated unit customized for a particular application, or the like. The display may be any suitable visual display unit such as, for example, a computer monitor, an LED, LCD, or plasma display, a television, a high definition television, an interactive white board, or a combination thereof.

The processing unit 830 includes a central processing unit (CPU) 838, memory 840, a mass storage device 842, a video adapter 844, and an I/O interface 846 connected to a bus 848. The bus 848 may be one or more of any type of several bus architectures including a memory bus or memory controller, a peripheral bus, video bus, or the like. The CPU 838 may be any type of electronic data processor. For example, the CPU 838 may be a processor from Intel Corp., a processor from Advanced Micro Devices, Inc., a Reduced Instruction Set Computer (RISC), an Application-Specific Integrated Circuit (ASIC), or the like. The memory 840 may be any type of system memory such as static random access memory (SRAM), dynamic random access memory (DRAM), synchronous DRAM (SDRAM), read-only memory (ROM), a combination thereof, or the like. Further, the memory 840 may include ROM for use at boot-up, and DRAM for data storage for use while executing programs.

The mass storage device 842 (e.g., a computer readable medium) may include any type of storage device configured to store data, programs, and other information and to make the data, programs, and other information accessible via the bus 848. In one or more embodiments, the mass storage device 842 stores software instructions to be executed by the CPU 838 to implement some or all of the network host operations of network association methods described herein. The mass storage device 842 may be, for example, one or more of a hard disk drive, a magnetic disk drive, an optical disk drive, or the like. The software instructions may be initially stored in a computer-readable medium such as a compact disc (CD), a diskette, a tape, a file, memory, or any other computer readable storage device and loaded and executed by the CPU 838. In some cases, the software may also be sold in a computer program product, which includes the computer-readable medium and packaging materials for the computer-readable medium. In some cases, the software may be distributed to the computer system 110 via removable computer readable media (e.g., floppy disk, optical disk, flash memory, USB key), via a transmission path from computer readable media on another computer system (e.g., a server), etc.

The video adapter 844 and the I/O interface 846 provide interfaces to couple external input and output devices to the processing unit 830. As illustrated in FIG. 8, examples of input and output devices include the display 834 and projector 112 coupled to the video adapter 844 and the mouse/keyboard 832 and the printer 836 coupled to the I/O interface 846.

The processing unit 830 also includes a network interface 847. The network interface 847 allows the processing unit 830 to communicate with remote units via a network (not shown). In one or more embodiments, the network interface 847 allows the computer system 110 to communicate via a network to the handheld calculators 118, 120. The network interface 847 may provide an interface for a wired link, such as an Ethernet cable or the like, or a wireless link.

The computer system 110 may also include other components not specifically shown. For example, the computer system 110 may include power supplies, cables, a motherboard, removable storage media, cases, and the like.

Computer system 110 may include camera 850, which may be a standalone camera that is coupled to processing unit 830 by a wired or wireless connection, for example. Camera 850 may be an embedded camera, such as is provided on many laptop and tablet computers, for example. A teacher may then ask each student to enter a keyboard sequence to cause the QR code to be displayed and then to place their calculator in proximity to camera 850.

In another embodiment, the teacher may use a smart phone 860 that has a camera and an application for reading QR codes from the students' calculator screens. The smart phone may be provided with an application that reads the QR codes and extracts the ID data represented by the QR code and then transfers the decoded data to computer system 110 by a wired or wireless connection, such as USB or Bluetooth, for example. In another embodiment, an application on the smart phone may capture the QR code image and transfer the captured image to the teacher's computer system where an application program may decode the QR image to extract the ID data.

FIG. 9 is a flow diagram of a method for taking inventory of handheld calculator devices and accessory devices in a classroom in order to configure network device association between the calculator devices and the network access point. Initially, an inventory process is requested by a network administrator, e.g., the teacher. Only those handheld calculators added to the classroom network in the configuration process will be allowed to connect to the classroom network in normal mode. Connection attempts by other devices will be rejected.

Initially, the teacher may request that students place their calculators in network configuration mode. Each student will then enter a predefined command sequence on the keypad of the student's calculator. For example, the command sequence may be selected from a menu, or from a command line, or be a specific command that is tapped in, etc.

For each calculator, the configuration command will be received 900 in response to the student's action to request a device identification (ID) for one of the devices connected to the calculator. As described earlier, such a device may be a wireless network module that is plugged into the calculator, a wireless network cradle that is supporting the calculator, a wireless network module that is embedded within the calculator, etc.

In response to receiving the configuration command, an application executed by a processor in the calculator will access a storage location that contains the device ID and then dynamically create 902 a unique ID image that is indicative of the device. In this embodiment, the unique ID image is in the form of a QR code. As described earlier, the resolution, or size, of the QR code may be predefined, based on expected data size requirements of school networks, for example.

The calculator application then cases the unique ID image to be displayed 904 on a display screen coupled to the device, so that the unique ID image is available to be observed by an inventory input device, such as a camera, for example.

While the students' calculators are displaying the QR codes, the teacher may request each student to bring their calculator to be viewed by a camera that is coupled to the network access point. As each student brings their calculator, the teacher may take a picture 906 of the dynamically created unique ID image on the display screen coupled to the device using the camera as the inventory input device to form a picture image containing the unique ID image.

Alternatively, the teacher may walk around the class room and may take a picture 906 of the dynamically created unique ID image on the display screens of the student calculators using a camera built into a smart phone or tablet computer, for example.

In either case, an ID number for the device may be determined 908 by processing the unique ID image in the picture image. In the first example, the processing may be performed the processor in computer node 110, for example. In the second example, the processing may be performed by an application executed on the smart phone or tablet computer. The determined ID number may then be transferred to computer node 110 via a wired or wireless connection, for example. Alternatively, the picture image may be transferred from the smart phone or tablet computer may be transferred to computer node 110 via a wired or wireless connection and processed 908 by the processor in computer node 110.

The ID number for the device may then be recorded 910 in an inventory list maintained by the computer node 110, for example. As explained earlier, the inventory list may be an associated device database that is maintained on the computer node 110 or in the access point 114, for example.

The wireless network controlled by access point 114 may then be configured 912 to allow the network module coupled to the calculator to communicate with the access point 114 by obtaining the ID number of the network module from the inventory list.

As described above, any device that has not been inventoried and included in the associated device database will not be allowed to connect to the network.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, embodiments are described herein in which the digital devices in the classroom network are handheld calculators. It should be noted, however, that other types of digital devices, e.g., laptop computers, desktop computers, tablet computers, and handheld computing devices may be used. Examples of other types of handheld computing devices include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

In various embodiments, the QR code on the handheld device may also encode other information about the handheld such as a product ID of the handheld calculator, memory usage, OS version number, etc. The desktop/smartphone application that reads the QR code to determine the network ID may decode this additional information and include the data in the inventory database, for example.

While the QR codes illustrated herein are in black and white, other embodiments may use squares of different colors other than black and white. In some embodiments, multiple colors may be used to encode additional data, for example.

Other embodiments may use data that is obtained from a dynamically generated ID image for other purposes besides network access. For example, it is often desirable to perform an inventory of equipment in various settings, such as equipment used in an office building, items for sale in a market place, equipment used in a manufacturing facility, etc, for example. An inventory may be performed on devices that have a display screen using the techniques described herein, for example.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for inventorying one or more devices, the method comprising:
receiving an input command to request a device identification (ID) for one of the devices;
dynamically creating a unique ID image that is indicative of the ID of one device; and
displaying the unique ID image on a display screen coupled to the one device, whereby the unique ID image is available to be observed by an inventory input device.

2. The method of claim 1, wherein the unique ID image is a quick response (QR) bar code.

3. The method of claim 1, wherein the display screen is comprised within a hand-held calculator, and wherein the one device is a network module coupled to the hand-held calculator.

4. The method of claim 1, further comprising:
taking a picture of the dynamically created unique ID image on the display screen coupled to the one device using a camera as the inventory input device to form a picture image containing the unique ID image;
determining an ID number for the one device by processing the unique ID image in the picture image by a remote device; and
recording the ID number for the one device in an inventory list maintained by the remote device.

5. The method of claim 4, wherein the one device is a network module, further comprising configuring a wireless network to allow the network module to communicate with the remote device by obtaining the ID number of the network module from the inventory list.

6. A method for inventorying one or more devices, the method comprising:
creating a picture image using a camera of a dynamically created unique identification (ID) image from a display screen coupled to one of the devices, wherein the unique ID image is indicative of the ID of the one device;
determining an ID number for the one device by processing the unique ID image contained in the picture image by a remote device; and
recording the ID number for the one device in an inventory list maintained by the remote device.

7. The method of claim 6, wherein the unique ID image is a quick response (QR) bar code.

8. The method of claim 6, wherein the display screen is comprised within a hand-held calculator, and wherein the one device is a network module coupled to the hand-held calculator.

9. The method of claim 8, further comprising configuring a wireless network to allow the network module to communicate with the remote device by obtaining the ID number of the network module from the inventory list.

10. A handheld calculator comprising:
a processor coupled to a storage memory, the processor operable to execute software instructions stored in the memory;
a display screen coupled to the processor; and
a wireless module coupled to the processor, wherein a unique identification (ID) number is stored within the wireless module;
wherein by executing the software instructions, the processor is operable to perform a method comprising:
receiving an input command to request a device identification (ID) for the wireless module;
dynamically creating a unique ID image that is indicative of the ID of the wireless module; and
displaying the unique ID image on the display screen, whereby the unique ID image is available to be observed by an inventory input device.

11. The calculator of claim 10, wherein the unique ID image is a quick response (QR) bar code.
